(19) United States
(12) Patent Application Publication
(10) Pub. No.: US 2026/0147450 A1
(43) Pub. Date: May 28, 2026

(54) SYSTEM AND METHOD FOR PROVIDING FUNCTIONALITIES TO CUSTOMIZE AND ENHANCE CONNECTIONS BETWEEN APPLICATIONS OF A SOFTWARE PROGRAM SUITE

(71) Applicant: BANK OF AMERICA CORPORATION, Charlotte, NC (US)

(72) Inventors: Alexander Rybalov, Colts Neck, NJ (US); Andrew Mize, Charlotte, NC (US)

(73) Assignee: BANK OF AMERICA CORPORATION, Charlotte, NC (US)

(21) Appl. No.: 18/956,769

(22) Filed: Nov. 22, 2024

(51) Int. Cl. G06F 3/0484; G06F 3/0482; G06F 9/451

(52) U.S. Cl. CPC G06F 3/0484; G06F 3/0482; G06F 9/451

(57) ABSTRACT

Embodiments of the present invention provide a system for providing functionalities to customize and enhance connections between applications of a software program suite. The system is configured for identifying that users accessed an analysis application of a software program suite to input data and generate analysis files comprising the data, identifying that the users accessed a presentation application of the software program suite to generate presentation files based on the data stored in the analysis files, allowing the users to link objects from the analysis files to the presentation files via a first single click functionality in the analysis application, extracting metadata associated with the objects from the analysis files and inserting the metadata into the presentation files, identifying changes to the data in the analysis files, and allowing the users to update the presentation files to reflect the changes via a second single click functionality in the presentation application.

### BACKGROUND

There exists a need for a system for providing functionalities to customize and enhance connections between applications of a software program suite.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for providing functionalities to customize and enhance connections between applications of a software program suite. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention identifies that one or more users accessed a data analysis application of a software program suite to input data and generate one or more data analysis documents comprising the data, via the data analysis application, identifies that the one or more users accessed a data presentation application of the software program suite to generate one or more data presentation documents based on the data stored in the one or more data analysis documents, allows the one or more users to link one or more objects from the one or more data analysis documents to the one or more data presentation documents via a first single click functionality in the data analysis application, in response to the one or more users using the first single click functionality to link the one or more objects from the one or more data analysis documents to the one or more data presentation documents, automatically extracts metadata associated with the one or more objects from the one or more data analysis documents and inserts the metadata into the one or more data presentation documents, identifies one or more changes to the data associated with the one or more objects, and allows the one or more users to update the one or more data presentation documents to reflect the one or more changes associated with the one or more objects, via a second single click functionality in the data presentation application.

In some embodiments, the present invention identifies the one or more changes based on receiving an input from the one or more users.

In some embodiments, the present invention identifies the one or more changes based on continuously monitoring the one or more data analysis documents.

In some embodiments, the present invention generates a custom user interface element in the data presentation application to display a first list comprising the one or more data analysis documents associated with the one or more changes on the custom user interface element, display a second list comprising the one or more objects associated with the one or more changes on the custom user interface element, and display the second single click functionality on the custom user interface element to update the one or more data presentation documents to reflect the one or more changes associated with the one or more objects.

In some embodiments, the present invention creates and integrates the first single click functionality into the data analysis application of the software program suite, wherein the first single click functionality is a custom built functionality to customize and enhance the data analysis application and connections associated with the data analysis application with other applications of the software program suite.

In some embodiments, the present invention creates and integrates the second single click functionality into the data presentation application of the software program suite, wherein the second single click functionality is a custom built functionality to customize and enhance the data presentation application and connections associated with the data presentation application with other applications of the software program suite.

In some embodiments, the one or more data analysis documents comprise one or more data sheets and the one or more data presentation documents comprise one or more presentation slides.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for providing functionalities to customize and enhance connections between applications of a software program suite, in accordance with an embodiment of the invention;

FIG. 2 provides a block diagram illustrating the entity system 200 of FIG. 1, in accordance with an embodiment of the invention;

FIG. 3 provides a block diagram illustrating an application connection enhancement system 300 of FIG. 1, in accordance with an embodiment of the invention;

FIG. 4 provides a block diagram illustrating the computing device system 400 of FIG. 1, in accordance with an embodiment of the invention;

FIG. 5 provides a process flow for providing functionalities to customize and enhance connections between applications of a software program suite, in accordance with an embodiment of the invention; and

FIG. 6 provides an example user interface of one or more enhancement functionalities created by the application connection enhancement system 300 of FIG. 1 for a data presentation application of the software program suite, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that utilizes a software program suite comprising a plurality of connected applications for performing one or more activities associated with the entity. In some embodiments, the entity may be a financial institution which may include herein may include any financial institutions such as commercial banks, thrifts, federal and state savings banks, savings and loan associations, credit unions, investment companies, insurance companies and the like. In some embodiments, the entity may be a non-financial institution. As described herein, a “user” may be an employee, potential customer, customer, and/or of the entity.

Many of the example embodiments and implementations described herein contemplate interactions engaged in by a user with a computing device and/or one or more communication devices and/or secondary communication devices. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Typically, a plurality of connected applications in a software program suite are utilized by an entity to perform one or more activities associated with the entity. In one example, a software program suite utilized by the entity may comprise a spreadsheet application, a presentation application, a publishing application, an email application, a document creation application, and/or the like. Typically, data may be stored in a first application for analysis (e.g., spreadsheet application) and a second application from the software program suite is used to present the data (e.g., presentation application) stored in the first application. However, when the volume of data is high and there are multiple spreadsheets (in one or more data input and analysis files generated by the spreadsheet application) that are linked to different parts of the data presentation document generated by the presentation application, it becomes challenging to update the data presentation document when data in the multiple spreadsheets is updated regularly, where a user has to update each link at a different instance which may lead to failure of the presentation application, where restart of presentation application multiple times may lead to unnecessary consumption of processing power, thereby decreasing overall efficiency of the spreadsheet application, the presentation application, and entity system/server hosting and executing these applications. As such, there exists a need for a system to overcome these technical challenges and enhance the connections between applications of the software program suite. The system of the present invention solves this problem as discussed in detail below.

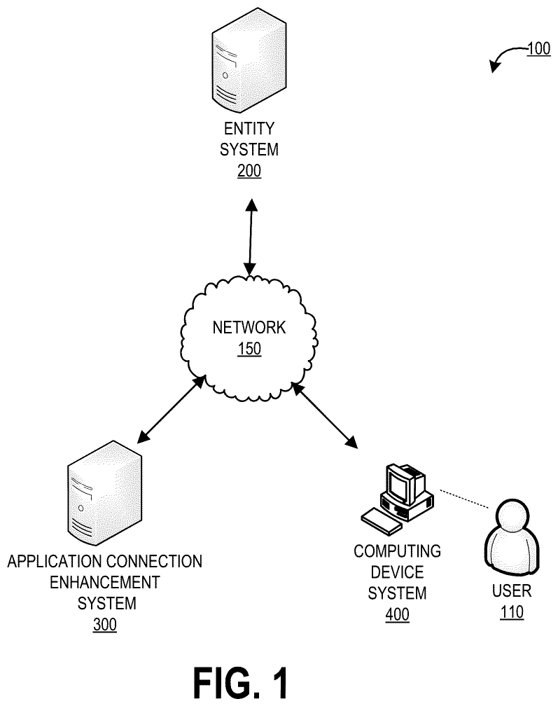

FIG. 1 provides a block diagram illustrating a system environment 100 for providing functionalities to customize and enhance connections between applications of a software program suite, in accordance with an embodiment of the invention. As illustrated in FIG. 1, the environment 100 includes an application connection enhancement system 300, an entity system 200, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be customers of an entity associated with the entity system 200. In some embodiments, the one or more users 110 may be potential customers of the entity associated with the entity system 200. In some embodiments, the one or more users 110 may be employees of the entity associated with the entity system 200.

The entity system(s) 200 may be any system owned or otherwise controlled by an entity to support or perform one or more process steps described herein. In some embodiments, the entity may be any organization that utilizes a software program suite comprising a plurality of connected applications for performing one or more activities associated with the entity. In some embodiments, the entity is a financial institution. In some embodiments, the entity is a non-financial institution.

The application connection enhancement system 300 is a system of the present invention for performing one or more process steps described herein. In some embodiments, the application connection enhancement system 300 may be an independent system. In some embodiments, the application connection enhancement system 300 may be a part of the entity system 200. In some embodiments, the application connection enhancement system 300 may be controlled, owned, managed, and/or maintained by the entity associated with the entity system 200.

The application connection enhancement system 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the application connection enhancement system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the application connection enhancement system 300, and/or entity system 200 across the network 150.

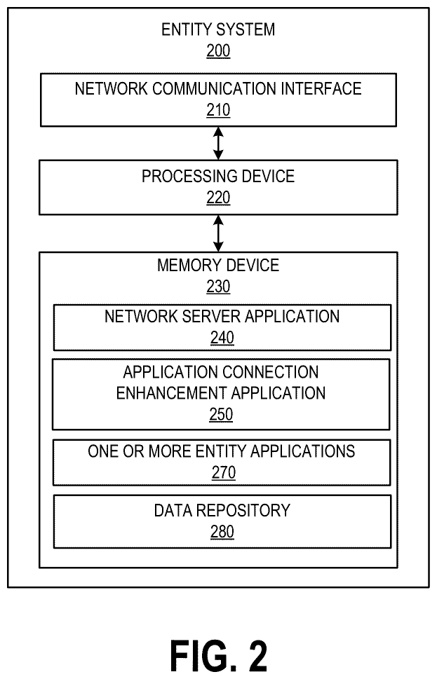

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution or a non-financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, an application connection enhancement application 250, one or more entity applications 270, and a data repository 280. The one or more entity applications 270 may be any applications developed, supported, maintained, utilized, and/or controlled by the entity. The computer-executable program code of the network server application 240, the application connection enhancement application 250, the one or more entity application 270 to perform certain logic, data-extraction, and data-storing functions of the entity system 200 described herein, as well as communication functions of the entity system 200.

The network server application 240, the application connection enhancement application 250, and the one or more entity applications 270 are configured to store data in the data repository 280 or to use the data stored in the data repository 280 when communicating through the network communication interface 210 with the application connection enhancement system 300, and/or the computing device system 400 to perform one or more process steps described herein. In some embodiments, the entity system 200 may receive instructions from the application connection enhancement system 300 via the application connection enhancement application 250 to perform certain operations. The application connection enhancement application 250 may be provided by the application connection enhancement system 300. The one or more entity applications 270 may be any of the applications used, created, modified, facilitated, developed, and/or managed by the entity system 200.

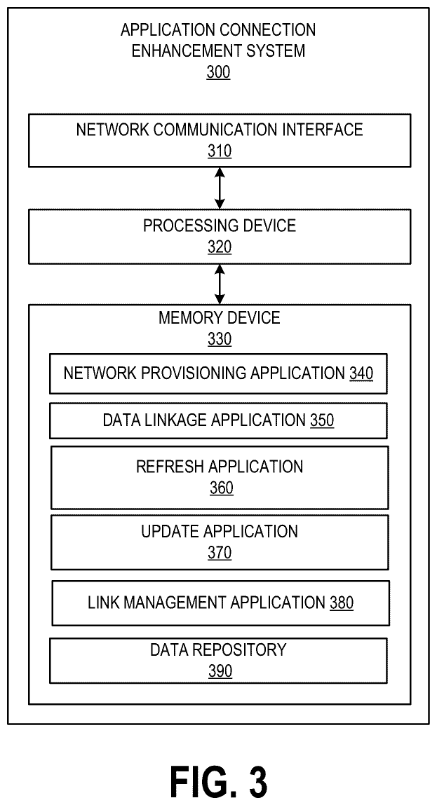

FIG. 3 provides a block diagram illustrating the application connection enhancement system 300 in greater detail, in accordance with embodiments of the invention. As illustrated in FIG. 3, in one embodiment of the invention, the application connection enhancement system 300 includes one or more processing devices 320 operatively coupled to a network communication interface 310 and a memory device 330. In certain embodiments, the application connection enhancement system 300 is operated by an entity, such as a financial institution. In some embodiments, the application connection enhancement system 300 is owned or operated by the entity of the entity system 200. In some embodiments, the application connection enhancement system 300 may be an independent system. In alternate embodiments, the application connection enhancement system 300 may be a part of the entity system 200.

It should be understood that the memory device 330 may include one or more databases or other data structures/repositories. The memory device 330 also includes computer-executable program code that instructs the processing device 320 to perform processing operations described herein and to operate the network communication interface 310 to perform certain communication functions of the application connection enhancement system 300. For example, in one embodiment of the application connection enhancement system 300, the memory device 330 includes, but is not limited to, a network provisioning application 340, a data linkage application 350, a refresh application 360, an update application 370, a link management application 380, and a data repository 390 comprising any data processed or accessed by one or more applications in the memory device 330. The computer-executable program code of the network provisioning application 340, the data linkage application 350, the refresh application 360, the update application 370, and the link management application 380 may instruct the processing device 320 to perform certain logic, data-processing, and data-storing functions of the application connection enhancement system 300 described herein, as well as communication functions of the application connection enhancement system 300.

The network provisioning application 340, the data linkage application 350, the refresh application 360, the update application 370, and the link management application 380 are configured to invoke or use the data in the data repository 390 when communicating through the network communication interface 310 with the entity system 200, and/or the computing device system 400. In some embodiments, the network provisioning application 340, the data linkage application 350, the refresh application 360, the update application 370, and the link management application 380 may store the data extracted or received from the entity system 200, and the computing device system 400 in the data repository 390. In some embodiments, the network provisioning application 340, the data linkage application 350, the refresh application 360, the update application 370, and the link management application 380 may be a part of a single application (e.g., modules).

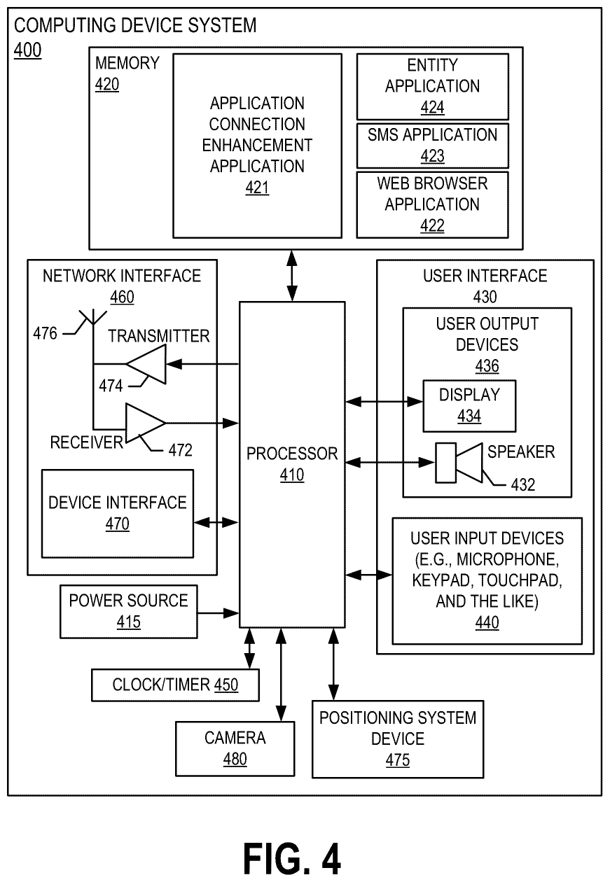

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the network. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, an application connection enhancement application 421, entity application 424. These applications also typically instructions to a graphical user interface (GUI) on the display 430 that allows the user 110 to interact with the entity system 200, the application connection enhancement system 300, and/or other devices or systems. The memory 420 of the computing device system 400 may comprise a Short Message Service (SMS) application 423 configured to send, receive, and store data, information, communications, alerts, and the like via the network. In some embodiments, the application connection enhancement application 421 provided by the application connection enhancement system 300 allows the user 110 to access the application connection enhancement system 300. In some embodiments, the entity application 424 provided by the entity system 200 and the application connection enhancement application 421 allow the user 110 to access the functionalities provided by the application connection enhancement system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

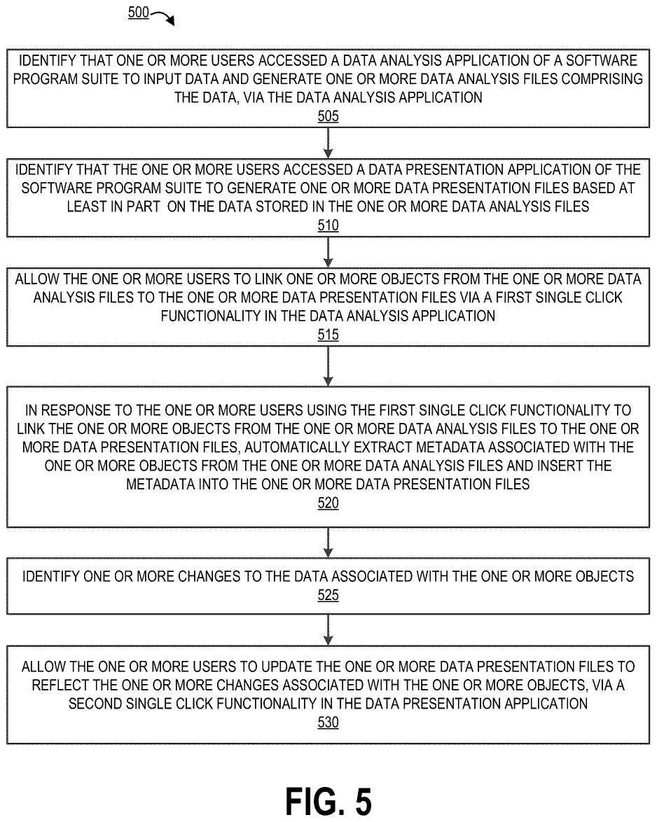

FIG. 5 provides a process flow for providing functionalities to customize and enhance connections between applications of a software program suite, in accordance with an embodiment of the invention. As shown in block 505, the system identifies that one or more users accessed a data analysis application of a software program suite to input data and generate one or more data analysis files comprising the data, via the data analysis application. In some embodiments, the system may utilize the software program suite comprising a plurality of application to perform one or more activities associated with the entity. In some embodiments, the data analysis application may generate the one or more data analysis files and store the data in a tabular format in the one or more data analysis files. In some embodiments, the one or more data analysis files may comprise one or more data sheets storing data associated with various categories or subcategories. The data may be any data associated with an entity that needs to be stored, analyzed, visualized, and/or the like. In some embodiments, the one or more users utilizing the plurality of application in the software program suite may be employees of the entity. In some embodiments, the one or more users utilizing the plurality of application in the software program suite may be customers or potential customers of the entity. In some embodiments, the software program suite may be provided by a third party entity and the system of the present invention may create additional functionalities (e.g., add-in, plugin, extension, and/or the like) on top of the features provided by the plurality of applications in the software program suite to enhance the functionality of the plurality of applications and also to enhance the connections between the plurality of applications in the software program suite.

As shown in block 510, the system identifies that the one or more users accessed a data presentation application of the software program suite to generate one or more data presentation files based at least in part on the data stored in the one or more data analysis files. In some embodiments, the one or more presentation files may comprise one or more presentation slides. In some embodiments, the data presentation application may generate the one or more data presentation files based on input received from the one or more users.

As shown in block 515, the system allows the one or more users to link one or more objects from the one or more data analysis files to the one or more data presentation files via a first single click functionality in the data analysis application. In some embodiment, the system of the present invention may create and integrate the first single click functionality into the data analysis application of the software program suite, wherein the first single click functionality is a custom built functionality to customize and enhance the data analysis application and connections associated with the data analysis application with other applications of the software program suite. In some embodiments, the single click functionality may comprise one or more executable instructions/program code to implement the functionalities of linking the one or more objects from the one or more data analysis files to the one or more data presentation files through a single click mechanism. In some embodiments, the single click functionality may comprise one or more executable instructions/program code to communicate with the system of the invention in real-time to implement the functionalities of linking the one or more objects from the one or more data analysis files to the one or more data presentation files through a single click mechanism.

In some embodiments, the one or more users may provide an input, to the system of the invention, associated with linking the one or more objects while generating the one or more data presentation files via the data presentation application. In some embodiments, the one or more users may provide the input, to the system of the invention, associated with linking the one or more objects after generating the one or more data presentation files via the data presentation application. In some embodiments, the one or more objects may be associated with one or more charts, one or more tables, one or more ranges, one or more images, and/or the like in the one or more data analysis files.

As shown in block 520, the system in response to the one or more users using the first single click functionality to link the one or more objects from the one or more data analysis files to the one or more data presentation files, automatically extracts metadata associated with the one or more objects from the one or more data analysis files and inserts the metadata into the one or more data presentation files. Extracting the metadata comprises extracting file name, file path, location of the data on the file, and/or the like. Extracting and inserting the metadata into the one or more data presentation files will not affect the one or more data presentation files even if the one or more data analysis files are deleted, malfunctioned, degraded, and/or the like. Typically, existing functionalities of the software program suite may not retain the data in the one or more data presentation files if the one or more data analysis files are deleted which is a major drawback where the files may be accidentally deleted, prone to file malfunction, prone to file degradation, deleted due to retention policies, and/or the like. Additionally, the existing functionalities of the software program suite typically allow the user to link the objects by performing at least seven to eight steps before the objects in the one or more data analysis files are successfully linked with the one or more data presentation files and even when the link is established, the link as explained is a live link and any file damages to the one or more data analysis files will affect the one or more data presentation files, which is not desirable. The system of the present invention overcomes the drawbacks of the existing functionalities of the data analysis application and the data presentation application in the software program suite by building additional enhanced custom functionalities.

As shown in block 525, the system identifies one or more changes to the data associated with the one or more objects. In some embodiments, the system may identify the one or more changes based on receiving an input from the one or more users. In some embodiments, the system may identify the one or more changes based on continuously monitoring the one or more data analysis documents. In some embodiments, the one or more changes may be associated with more than one data analysis files and/or more than one sheet in each of the data analysis files, where each of the one or more changes may be performed by more than one user at different instances.

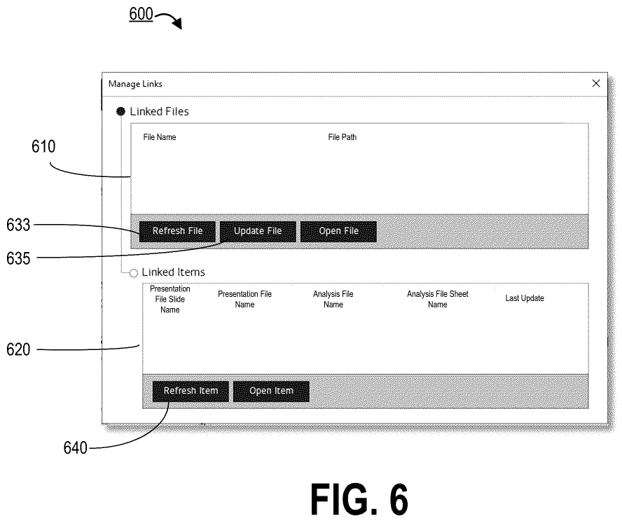

As shown in block 530, the system allows the one or more users to update the one or more data presentation files to reflect the one or more changes associated with the one or more objects, via a second single click functionality in the data presentation application. In some embodiments, the system creates and integrates the second single click functionality into the data presentation application of the software program suite, wherein the second single click functionality is a custom built functionality to customize and enhance the data presentation application and connections associated with the data presentation application with other applications of the software program suite. Typically existing functionalities of the live links provided by the software program suite require the users to update each object individually at separate instances whenever there is a change to the object and when the volume of the data is high and there are multiple presentation slides, individual updating of the objects by performing three to four steps may result in failure of the data presentation application. The system of the present invention overcomes the drawbacks of the existing functionalities of the data analysis application and the data presentation application in the software program suite by building additional enhanced custom functionalities (e.g., the second single click functionalities shown in FIG. 6).

In some embodiments, the system generate a custom user interface element in the data presentation application to display a first list comprising the one or more data analysis documents associated with the one or more changes on the custom user interface element, display a second list comprising the one or more objects associated with the one or more changes on the custom user interface element, and display the second single click functionality on the custom user interface element to update the one or more data presentation documents to reflect the one or more changes associated with the one or more objects. An example of such a user interface element is shown in FIG. 6.

FIG. 6 provides an example user interface of one or more enhancement functionalities created by the application connection enhancement system 300 of FIG. 1 for a data presentation application of the software program suite, in accordance with an embodiment of the invention. As shown, the system display a first list 610 comprising the one or more data analysis documents associated with the one or more changes and a second list 620 comprising the one or more objects associated with the one or more changes on the custom user interface element. As shown, the system may allow the users to update all files or selected files using a single click functionality 635 and refresh all files or selected files to reflect changes to the data via the single click functionality 633. As shown, the system may also allow the users to update all objects or selected objects in data analysis file via a single click functionality 640.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for providing functionalities to customize and enhance connections between applications of a software program suite, the system comprising:
at least one network communication interface;
at least one non-transitory storage device; and
at least one processing device coupled to the at least one non-transitory storage device and the at least one network communication interface, wherein the at least one processing device is configured to:
identify that one or more users accessed a data analysis application of a software program suite to input data and generate one or more data analysis files comprising the data, via the data analysis application;
identify that the one or more users accessed a data presentation application of the software program suite to generate one or more data presentation files based on the data stored in the one or more data analysis files;
allow the one or more users to link one or more objects from the one or more data analysis files to the one or more data presentation files via a first single click functionality in the data analysis application;
in response to the one or more users using the first single click functionality to link the one or more objects from the one or more data analysis files to the one or more data presentation files, automatically extract metadata associated with the one or more objects from the one or more data analysis files and inserting the metadata into the one or more data presentation files;
identify one or more changes to the data associated with the one or more objects; and
allow the one or more users to update the one or more data presentation files to reflect the one or more changes associated with the one or more objects, via a second single click functionality in the data presentation application.

2. The system of claim 1, wherein the at least one processing device is configured to identify the one or more changes based on receiving an input from the one or more users.

3. The system of claim 1, wherein the at least one processing device is configured to identify the one or more changes based on continuously monitoring the one or more data analysis files.

4. The system of claim 1, wherein in response to identifying the one or more changes, the at least one processing device is configured to generate a custom user interface element in the data presentation application to:
display a first list comprising the one or more data analysis files associated with the one or more changes on the custom user interface element;
display a second list comprising the one or more objects associated with the one or more changes on the custom user interface element; and
display the second single click functionality on the custom user interface element to update the one or more data presentation files to reflect the one or more changes associated with the one or more objects.

5. The system of claim 1, wherein the at least one processing device is configured to create and integrate the first single click functionality into the data analysis application of the software program suite, wherein the first single click functionality is a custom built functionality to customize and enhance the data analysis application and connections associated with the data analysis application with other applications of the software program suite.

6. The system of claim 1, wherein the at least one processing device is configured to create and integrate the second single click functionality into the data presentation application of the software program suite, wherein the second single click functionality is a custom built functionality to customize and enhance the data presentation application and connections associated with the data presentation application with other applications of the software program suite.

7. The system of claim 1, wherein the one or more data analysis files comprise one or more data sheets and the one or more data presentation files comprise one or more presentation slides.

8. A computer program product for providing functionalities to customize and enhance connections between applications of a software program suite, the computer program product comprising a non-transitory computer-readable storage medium having computer executable instructions for causing a computer processor to perform the steps of:
identifying that one or more users accessed a data analysis application of a software program suite to input data and generate one or more data analysis files comprising the data, via the data analysis application;
identifying that the one or more users accessed a data presentation application of the software program suite to generate one or more data presentation files based on the data stored in the one or more data analysis files;
allowing the one or more users to link one or more objects from the one or more data analysis files to the one or more data presentation files via a first single click functionality in the data analysis application;
in response to the one or more users using the first single click functionality to link the one or more objects from the one or more data analysis files to the one or more data presentation files, automatically extracting metadata associated with the one or more objects from the one or more data analysis files and inserting the metadata into the one or more data presentation files;
identifying one or more changes to the data associated with the one or more objects; and
allowing the one or more users to update the one or more data presentation files to reflect the one or more changes associated with the one or more objects, via a second single click functionality in the data presentation application.

9. The computer program product of claim 8, wherein the computer executable instructions cause the computer processor to perform the step of identifying the one or more changes based on receiving an input from the one or more users.

10. The computer program product of claim 8, wherein the computer executable instructions cause the computer processor to perform the step of identifying the one or more changes based on continuously monitoring the one or more data analysis files.

11. The computer program product of claim 8, wherein the computer executable instructions cause the computer processor to perform the step of generating a custom user interface element in the data presentation application to:
display a first list comprising the one or more data analysis files associated with the one or more changes on the custom user interface element;
display a second list comprising the one or more objects associated with the one or more changes on the custom user interface element; and
display the second single click functionality on the custom user interface element to update the one or more data presentation files to reflect the one or more changes associated with the one or more objects.

12. The computer program product of claim 8, wherein the computer executable instructions cause the computer processor to perform the step of creating and integrating the first single click functionality into the data analysis application of the software program suite, wherein the first single click functionality is a custom built functionality to customize and enhance the data analysis application and connections associated with the data analysis application with other applications of the software program suite.

13. The computer program product of claim 8, wherein the computer executable instructions cause the computer processor to perform the step of creating and integrating the second single click functionality into the data presentation application of the software program suite, wherein the second single click functionality is a custom built functionality to customize and enhance the data presentation application and connections associated with the data presentation application with other applications of the software program suite.

14. The computer program product of claim 8, wherein the one or more data analysis files comprise one or more data sheets and the one or more data presentation files comprise one or more presentation slides.

15. A computer implemented method for providing functionalities to customize and enhance connections between applications of a software program suite, wherein the method comprises:
identifying that one or more users accessed a data analysis application of a software program suite to input data and generate one or more data analysis files comprising the data, via the data analysis application;
identifying that the one or more users accessed a data presentation application of the software program suite to generate one or more data presentation files based on the data stored in the one or more data analysis files;
allowing the one or more users to link one or more objects from the one or more data analysis files to the one or more data presentation files via a first single click functionality in the data analysis application;
in response to the one or more users using the first single click functionality to link the one or more objects from the one or more data analysis files to the one or more data presentation files, automatically extracting metadata associated with the one or more objects from the one or more data analysis files and inserting the metadata into the one or more data presentation files;
identifying one or more changes to the data associated with the one or more objects; and
allowing the one or more users to update the one or more data presentation files to reflect the one or more changes associated with the one or more objects, via a second single click functionality in the data presentation application.

16. The computer implemented method of claim 15, wherein identifying the one or more changes is based on receiving an input from the one or more users.

17. The computer implemented method of claim 15, wherein identifying the one or more changes is based on continuously monitoring the one or more data analysis files.

18. The computer implemented method of claim 15, wherein the method further comprises generating a custom user interface element in the data presentation application to:
display a first list comprising the one or more data analysis files associated with the one or more changes on the custom user interface element;
display a second list comprising the one or more objects associated with the one or more changes on the custom user interface element; and
display the second single click functionality on the custom user interface element to update the one or more data presentation files to reflect the one or more changes associated with the one or more objects.

19. The computer implemented method of claim 15, wherein the method comprises creating and integrating the first single click functionality into the data analysis application of the software program suite, wherein the first single click functionality is a custom built functionality to customize and enhance the data analysis application and connections associated with the data analysis application with other applications of the software program suite.

20. The computer implemented method of claim 15, wherein the method comprises creating and integrating the second single click functionality into the data presentation application of the software program suite, wherein the second single click functionality is a custom built functionality to customize and enhance the data presentation application and connections associated with the data presentation application with other applications of the software program suite.
